(19) United States
(12) Patent Application Publication
(10) Pub. No.: US 2025/0389820 A1
(43) Pub. Date: Dec. 25, 2025

(54) LASER RADAR AND ROBOT

(71) Applicant: HangZhou YuShu TECHNOLOGY CO.,LTD., Hangzhou (CN)

(72) Inventors: Xingxing WANG, Hangzhou (CN); Xiaoyang BAI, Hangzhou (CN)

(21) Appl. No.: 19/102,695

(22) PCT Filed: Dec. 19, 2022
(86) PCT No.: PCT/CN2022/139880

§ 371 Date: Feb. 10, 2025

(30) Foreign Application Priority Data
Aug. 10, 2022 (CN) 202210955344.2
Aug. 10, 2022 (CN) 202222114215.9

(51) Int. Cl. G01S 7/481; A47L 9/28; A47L 11/40; G01D 5/347; G01S 17/931

(52) U.S. Cl. CPC G01S 7/4817; A47L 9/2805; A47L 9/2868; A47L 11/4005; A47L 11/4011; G01D 5/34707; G01D 5/3473; G01S 7/4813; G01S 17/931

(57) ABSTRACT

In a 3D laser radar, a light shielding chamber is provided between a reflecting mirror and a protective cover, the light shielding chamber is directly fixed on a rotation axis of the reflecting mirror along a laser signal transmission direction, and an arc-shaped part close to a rotation trajectory of an end portion of the light shielding chamber is provided on the protective cover, such that a distance between the end portion and the arc-shaped part remains unchanged during rotation of the light shielding chamber. By providing the light shielding chamber between the reflecting mirror and the protective cover, scattering and reflection of a laser signal transmitted from the reflecting mirror in the protective cover are reduced, avoiding interference to a laser signal on a return path, and thereby improving the scanning performance of the laser radar.

### TECHNICAL FIELD

The present application relates to the technical field of laser radars, and in particular to a laser radar and a robot.

### BACKGROUND

Currently, 3D laser radars are widely used in fields such as industrial surveying and mapping, three-dimensional modeling and autonomous driving. However, most of the existing 3D laser radars are multi-threaded laser radars, which are very expensive.

Chinese patent No. CN113960566A discloses a 3D laser radar and a legged robot. The 3D laser radar includes a vertical scanning unit and a horizontal rotating device enabling the vertical scanning unit to rotate in a horizontal direction. The vertical scanning unit includes a mounting base, and a laser receiver, a convex lens, a laser transmitter and a reflector sequentially provided on the mounting base. The laser receiver is provided at a focus position of the convex lens. The laser transmitter is provided on a main optical axis of the convex lens. The reflector is rotatably provided on the mounting base. A rotation center of the reflector coincides with the main optical axis of the convex lens. The laser transmitter transmits a laser pulse signal to achieve surrounding environment scanning in a vertical plane through the rotation of the reflector and achieve three-dimensional environment scanning through the horizontal rotating device provided with a rotating motor.

### SUMMARY

### Technical Problems

The above technical solution achieves three-dimensional scanning using a single-threaded laser radar. However, during use of the technical solution, it is found that as a light shielding channel is far away from a protective cover, scattering of a laser signal occurs in the protective cover after the laser signal is transmitted out from the light shielding channel and before the laser signal passes through the protective cover, causing interference to a laser signal on a return path, thereby affecting reception of the laser signal by a laser receiver. As such, a scanning result of the laser radar is non-ideal, resulting in poor user experience, which is not conducive to use promotion.

Further, reflection of the laser signal transmitted from a laser transmitter occurs when the laser signal passes through the protective cover on a mounting base, thereby affecting the reception of the laser signal on the return path by the laser receiver.

### Solutions to Technical Problems

### Technical Solutions

In order to overcome the defects of the existing technology, a first purpose of the present application is to provide a 3D laser radar, in which a light shielding chamber is provided between a reflecting mirror and a protective cover, to reduce scattering and reflection of a laser signal transmitted from the reflecting mirror in the protective cover, thereby improving the scanning performance of the laser radar.

A second purpose of the present application is to provide a 3D laser radar, in which during rotation of a light shielding chamber with a reflecting mirror, a distance between an end portion of the light shielding chamber and an arc-shaped part remains unchanged, so that scattering and reflection of a transmitted laser signal in a protective cover remain unchanged, resulting in a more stable scanning result of the laser radar for an external environment.

A third purpose of the present application is to provide a laser radar with high scanning performance, in which a light shielding chamber is provided between a reflector and a protective housing, to reduce scattering and reflection of a laser signal transmitted from the reflector in the protective housing, thereby improving the scanning performance of the laser radar.

A fourth purpose of the present application is to provide a laser radar with high scanning performance and a robot, in which during rotation of a light shielding chamber with a reflector, a distance between an end portion of the light shielding chamber and an arc-shaped part remains unchanged, so that scattering and reflection of a transmitted laser signal in a protective housing remain unchanged, resulting in a more stable scanning result of the laser radar for an external environment.

A fifth purpose of the present application is to provide a legged robot equipped with a 3D laser radar, in which a light shielding chamber is provided between a reflecting mirror and a protective cover, to reduce scattering and reflection of a laser signal transmitted from the reflecting mirror in the protective cover, thereby improving the scanning performance of the laser radar.

A sixth purpose of the present application is to provide a cleaning robot equipped with a 3D laser radar, in which a light shielding chamber is provided between a reflecting mirror and a protective cover, to reduce scattering and reflection of a laser signal transmitted from the reflecting mirror in the protective cover, thereby improving the scanning performance of the laser radar.

In order to achieve one of the above purposes, the first technical solution of the present application is as follows:
A 3D laser radar includes a vertical scanning unit, where the vertical scanning unit includes a mounting base and a protective cover fixed on the mounting base;
A laser transmitting port, a convex lens, and a rotatable reflecting mirror are horizontally provided between the mounting base and the protective cover in sequence, a rotation axis of the reflecting mirror coincides with a main optical axis of the convex lens, and the laser transmitting port is provided on the main optical axis of the convex lens; a laser signal horizontally transmitted from the laser transmitting port achieves surrounding environment scanning in a vertical plane through reflection and rotation by the reflecting mirror.

A light shielding chamber is provided between a reflecting mirror and a protective cover, the light shielding chamber extends along a laser signal reflection direction and is provided on the rotation axis of the reflecting mirror, and an arc-shaped part close to a rotation trajectory of an end portion of the light shielding chamber is provided on the protective cover, such that a distance between the end portion and the arc-shaped part remains unchanged during rotation of the light shielding chamber.

After continuous exploration and experimentation, in the present application, the light shielding chamber is provided between the reflecting mirror and the protective cover, to reduce scattering and reflection of a laser signal transmitted from the reflecting mirror in the protective cover, avoiding interference to a laser signal on a return path, and thereby improving the scanning performance of the laser radar. The structure is simple and practical, the manufacturing cost is low, and the user experience is improved, thereby facilitating the use promotion.

Further, in the present application, during rotation of the light shielding chamber with the reflecting mirror, the distance between the end portion of the light shielding chamber and the arc-shaped part remains unchanged, so that scattering and reflection of a transmitted laser signal in the protective cover remain unchanged, resulting in a more stable scanning result of the laser radar for an external environment.

As an exemplary technical measure, the transverse light shielding member is provided between the laser transmitting port and the reflecting mirror, the transverse light shielding member includes a first light shielding member fixed on the main optical axis of the convex lens and a second light shielding member directly fixed on and rotating with the reflecting mirror, and the second light shielding member is sleeved with the first light shielding member; the transverse light shielding member is in communication with the light shielding chamber, and a light shielding pad is provided at a portion of the second light shielding member and the light shielding chamber that is in contact with the reflecting mirror. By providing the transverse light shielding member in the horizontal direction, a transmitted laser signal is prevented from interfering with a laser signal on a return path, and refrains from leaking into an internal space of the protective cover to interfere with the laser signal on the return path. The transverse light shielding member is in set to be a structure consisting of the first light shielding member and the second light shielding member separated from each other, and the second light shielding member is sleeved with the first light shielding member on the outer side thereof, so as to avoid reflection of the transmitted laser signal by the second light shielding member which may affect the scanning performance of the laser radar.

As an exemplary technical measure, the vertical scanning unit includes a laser receiver provided at a focus position of the convex lens, a first motor driving the reflecting mirror to rotate, and a first encoder; the first encoder is concentrically fixed and connected to the reflecting mirror, to acquire rotation information of the reflecting mirror through the first encoder; the laser transmitting port transmits a laser signal, and the reflecting mirror is driven to rotate through the first motor, to achieve the surrounding environment scanning in the vertical plane.

As an exemplary technical measure, the 3D laser radar includes a horizontal rotating device driving the vertical scanning unit to rotate horizontally, where the horizontal rotating device includes an upper casing rotor, a lower casing, and a motor stator fixed in the lower casing, the mounting base and the protective cover are fixed on and rotate with the upper casing rotor, and a mobile sealing structure is provided between the upper casing rotor and the lower casing. The horizontal rotating device drives the vertical scanning unit to rotate in the horizontal direction, enabling the single-threaded laser radar to achieve three-dimensional scanning. The mobile sealing structure is provided to enhance overall waterproofness of the laser radar, enriching application scenarios thereof.

As an exemplary technical measure, a hollow wireless power transmission module is concentrically provided between the upper casing rotor and the lower casing, and the wireless power transmission module supplies power to the vertical scanning unit. Due to the relative rotation between the upper casing rotor and the lower casing, when power supply and signal transmission are required, the wireless power transmission module is used for replacing a conventional cable, thus avoiding fatigue damage of the cable during reciprocating rotation.

And/or, through holes are uniformly provided along the same circle on a circumference of the upper casing rotor, and the through holes form a photoelectric code disk to acquire rotation information of the upper casing rotor, thereby acquiring horizontal rotation information of the vertical scanning unit

And/or, a magnetic steel sheet is fixedly provided in the upper casing rotor, an axial width of the magnetic steel sheet is greater than an axial width of the motor stator, and an upper edge of the magnetic steel sheet is higher than an upper edge of the motor stator. The design of this structure enables the magnetic steel sheet to be higher than the motor stator by an amount in the vertical direction, making it possible to generate a large axial magnetic tension between the upper casing rotor and the motor stator, thus making rotation of the horizontal rotating device more stable and reliable, and ensuring that the upper casing rotor is not separated from the lower casing during the rotation.

As an exemplary technical measure, a base circuit board is fixedly provided on the lower casing, a wireless signal transmission component is concentrically provided between the upper casing rotor and the lower casing, and achieves wireless communication through optical communication; the vertical scanning unit achieves wireless communication with the base circuit board through the wireless signal transmission component.

In order to achieve one of the above purposes, the second technical solution of the present application is as follows:

A 3D laser radar includes a rotatable reflecting mirror used for reflecting a laser signal and a protective cover of an arc-shaped structure.

A light shielding chamber is provided between the protective cover and the reflecting mirror; the light shielding chamber is a cylindrical structure having an outer end portion with an arc rotation trajectory and being capable of rotating with the reflecting mirror.

An arc-shaped part used for covering the light shielding chamber is provided on the protective cover.

A portion or all of a sectional shape of the arc-shaped part and the rotation trajectory of the outer end portion are concentric arcs to form a structure with an invariant gap, so that a distance between the end portion and the arc-shaped part remains unchanged during rotation of the light shielding chamber.

After continuous exploration and experimentation, in the present application, the light shielding chamber is provided between the reflecting mirror and the protective cover, to reduce scattering and reflection of a laser signal transmitted from the reflecting mirror in the protective cover, avoiding interference to a laser signal on a return path, and thereby improving the scanning performance of the laser radar. The structure is simple and practical, the manufacturing cost is low, and the user experience is improved, thereby facilitating the use promotion.

Further, in the present application, the sectional shape of the arc-shaped part and the rotation trajectory of the outer end portion are concentric arcs to form the structure with an invariant gap, so that during the rotation of the light shielding chamber with the reflecting mirror, the distance between the end portion of the light shielding chamber and the arc-shaped part remains unchanged, enabling scattering and reflection of a transmitted laser signal in the protective cover to remain unchanged, resulting in a more stable scanning result of the laser radar for an external environment.

As an exemplary technical measure:
the cylindrical structure is an L-shaped structure with a vertical segment used for receiving a laser signal reflected from the reflecting mirror and a transverse segment used for receiving a laser signal transmitted from a convex lens;
the vertical segment extends towards a wall of the protective cover and is adjacent to the wall of the protective cover;
a first light shielding member is provided on the convex lens;
the transverse segment of the L-shaped structure is sleeved with the first light shielding member on the outer side thereof.

In order to achieve one of the above purposes, the third technical solution of the present application is as follows:

A 3D laser radar includes a rotatable reflecting mirror used for reflecting a laser signal and a protective cover of an arc-shaped structure.

A light shielding chamber is provided between the protective cover and the reflecting mirror; and the light shielding chamber is a cylindrical structure which extends in a direction from an end face of the reflecting mirror to a wall of the protective cover.

After continuous exploration and experimentation, in the present application, the light shielding chamber is provided between the reflecting mirror and the protective cover, to reduce scattering and reflection of a laser signal transmitted from the reflecting mirror in the protective cover, avoiding interference to a laser signal on a return path, and thereby improving the scanning performance of the laser radar. The structure is simple and practical, the manufacturing cost is low, and the user experience is improved, thereby facilitating the use promotion.

Further, the reflecting mirror is an object capable of reflecting light, including but not limited to a reflecting mirror, a reflective mirror, a reflecting film, or other reflecting materials common in the prior art. In order to achieve one of the above purposes, the fourth technical solution of the present application is as follows:

A laser radar with high scanning performance includes:

a laser transmitter used for transmitting a laser signal, a rotatable reflector used for reflecting a laser signal, and a protective housing of an arc-shaped structure.

The protective housing covers the reflector.

A light shielding chamber is provided between the reflector and the protective housing.

The light shielding chamber is a cylindrical member which extends in a direction from an end face of the reflector to a wall of the protective housing.

After continuous exploration and experimentation, in the present application, the light shielding chamber is provided between the reflector and the protective housing, to reduce scattering and reflection of a laser signal transmitted from the reflector in the protective housing, avoiding interference to a laser signal on a return path, and thereby improving the scanning performance of the laser radar. The structure is simple and practical, the manufacturing cost is low, and the user experience is improved, thereby facilitating the use promotion.

Further, the reflector is a reflecting mirror, a reflective mirror, a reflecting film, or other reflecting materials.

As an exemplary technical measure:
the laser transmitter is arranged transversely and is provided with a laser transmitting port;
the reflector is provided with a reflecting face arranged obliquely;
an extension line where the laser transmitting port is located intersects the reflecting face, so as to reflect a laser signal.

As an exemplary technical measure:
the cylindrical member is an L-shaped structure with a vertical segment used for receiving a laser signal reflected from the reflector and a transverse segment used for receiving a laser signal transmitted from a convex lens;
the vertical segment extends towards a wall of the protective housing and is adjacent to the wall of the protective housing;
The light shielding chamber is provided with the transverse segment in the horizontal direction, so that a transmitted laser signal is prevented from interfering with a laser signal on a return path, and refrains from leaking into an internal space of the protective housing to interfere with the laser signal on the return path.

As an exemplary technical measure:
a first light shielding member is provided on the convex lens, and a laser receiver is provided at a focus position of the convex lens;
The transverse segment of the L-shaped structure is sleeved with the first light shielding member on the outer side thereof, so as to avoid reflection of the transmitted laser signal by the second light shielding member which may affect the scanning performance of the laser radar.

In order to achieve one of the above purposes, the fifth technical solution of the present invention is as follows:
the cylindrical member is provided on a rotation axis of the reflector, and an outer end thereof has an arc rotation trajectory and is capable of rotating with the reflector;
an arc-shaped part used for covering the light shielding chamber is provided on the protective housing; a portion or all of a sectional shape of the arc-shaped part and the rotation trajectory of the outer end portion are concentric arcs to form a structure with an invariant gap, so that a distance between the end portion and the arc-shaped part remains unchanged during rotation of the light shielding chamber.

In the present application, during rotation of the light shielding chamber with the reflector, the distance between the end portion of the light shielding chamber and the arc-shaped part remains unchanged, so that scattering and reflection of a transmitted laser signal in the protective housing remain unchanged, resulting in a more stable scanning result of the laser radar for an external environment.

As an exemplary technical measure:
the rotation axis of the reflector coincides with a main optical axis of the convex lens, and the laser transmitting port is provided on the main optical axis of the convex lens; a laser signal horizontally transmitted from the laser transmitting port achieves surrounding environment scanning in a vertical plane through reflection and rotation by the reflector. As an exemplary technical measure:

a transverse light shielding member is provided between the laser transmitter and the reflector, the transverse light shielding member comprises the first light shielding member fixed on the main optical axis of the convex lens and a second light shielding member directly fixed on and rotating with the reflector, and the second light shielding member is sleeved with the first light shielding member;
the transverse light shielding member is in communication with the light shielding chamber, and a light shielding pad is provided at a portion of the second light shielding member and the light shielding chamber that is in contact with the reflector.

By providing the transverse light shielding member in the horizontal direction, a transmitted laser signal is prevented from interfering with a laser signal on a return path, and refrains from leaking into an internal space of the protective housing to interfere with the laser signal on the return path. The transverse light shielding member is set to be a structure consisting of the first light shielding member and the second light shielding member separated from each other, and the second light shielding member is sleeved with the first light shielding member on the outer side thereof, so as to avoid reflection of the transmitted laser signal by the second light shielding member which may affect the scanning performance of the laser radar.

In order to achieve one of the above purposes, the sixth technical solution of the present invention is as follows:

A robot uses the 3D laser radar as described above to achieve real-time scanning of surrounding environment information.

The robot is a legged robot or a cleaning robot.

In order to achieve one of the above purposes, the seventh technical solution of the present invention is as follows:

A robot includes the laser radar with high scanning performance as described above, where the robot is a legged robot or a cleaning robot.

### Beneficial Effects of the Present Application

### Beneficial Effects

In the 3D laser radar provided by the present application, the light shielding chamber is provided between the reflecting mirror and the protective cover to reduce scattering and reflection of a laser signal transmitted from the reflecting mirror in the protective cover, avoiding interference to a laser signal on a return path, and thereby improving the scanning performance of the laser radar. Moreover, during the rotation of the light shielding chamber with the reflecting mirror, the distance between the end portion of the light shielding chamber and the arc-shaped part remains unchanged, so that scattering and reflection of a transmitted laser signal in the protective cover remain unchanged, resulting in a more stable scanning result of the laser radar for an external environment.

In the cleaning robot equipped with the 3D laser radar provided by the present application, the light shielding chamber is provided between the reflecting mirror and the protective cover to reduce scattering and reflection of a laser signal transmitted from the reflecting mirror in the protective cover, avoiding interference to a laser signal on a return path, and thereby improving the scanning performance of the laser radar. Moreover, during the rotation of the light shielding chamber with the reflecting mirror, the distance between the end portion of the light shielding chamber and the arc-shaped part remains unchanged, so that scattering and reflection of a transmitted laser signal in the protective cover remain unchanged, resulting in a more stable scanning result of the laser radar for an external environment.

In the legged robot equipped with the 3D laser radar provided by the present application, the light shielding chamber is provided between the reflecting mirror and the protective cover to reduce scattering and reflection of a laser signal transmitted from the reflecting mirror in the protective cover, avoiding interference to a laser signal on a return path, and thereby improving the scanning performance of the laser radar. Moreover, during the rotation of the light shielding chamber with the reflecting mirror, the distance between the end portion of the light shielding chamber and the arc-shaped part remains unchanged, so that scattering and reflection of a transmitted laser signal in the protective cover remain unchanged, resulting in a more stable scanning result of the laser radar for an external environment.

### BRIEF DESCRIPTION OF THE DRAWINGS

### Description of the Drawings

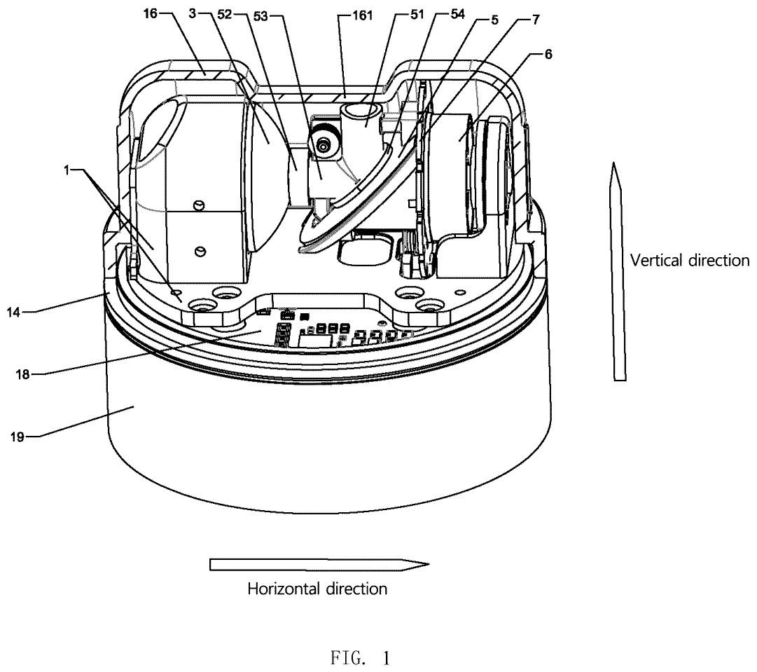

FIG. 1 is a schematic diagram of an overall structure of a 3D laser radar according to the present application;

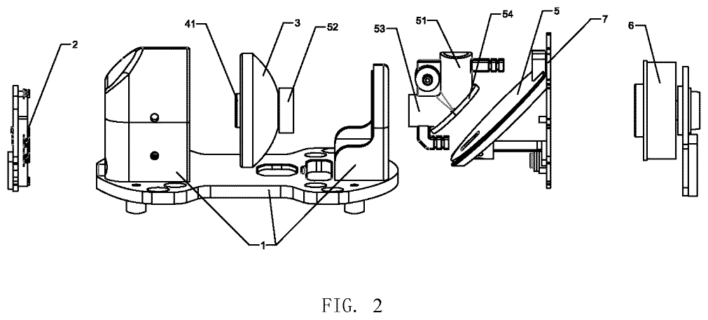

FIG. 2 is an exploded view of a vertical scanning unit of a 3D laser radar according to the present application;

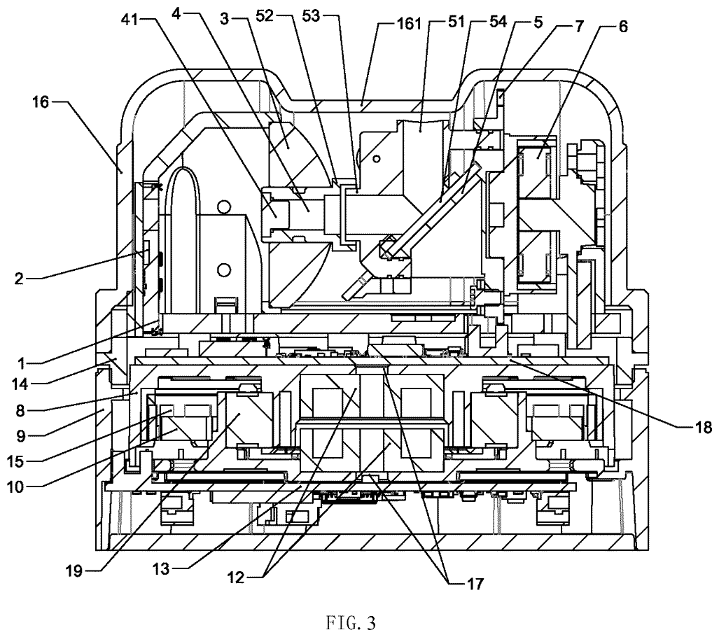

FIG. 3 is a full sectional view of a 3D laser radar according to the present application;

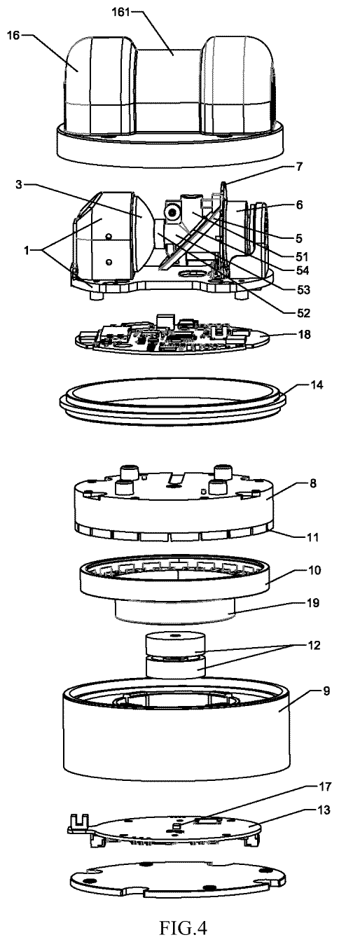

FIG. 4 is an exploded view of a 3D laser radar according to the present application; and

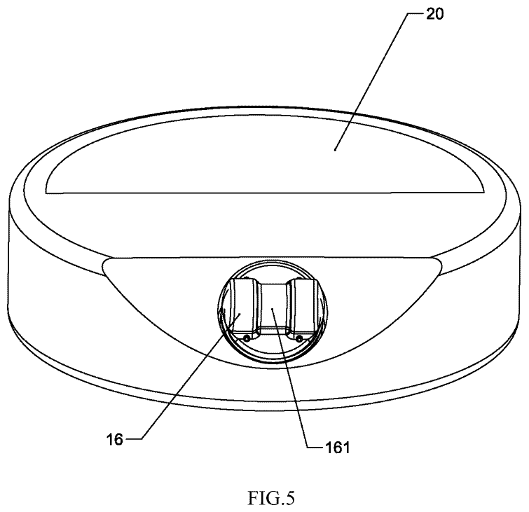

FIG. 5 is a schematic diagram of an overall structure of a cleaning robot according to the present application.

In the drawings, 1—mounting base; 2—laser receiver; 3—convex lens; 4—laser transmitting port; 5—reflecting mirror; 51—light shielding chamber; 52—first light shielding member; 53—second light shielding member; 54—light shielding pad; 6—first motor; 7—first encoder; 8—upper casing rotor; 9—lower casing; 10—motor stator; 11—through hole; 12—wireless power transmission module; 13—base circuit board; 14—mobile sealing structure; 15—magnetic steel sheet; 16—protective cover; 161—arc-shaped part; 17—wireless signal transmission component; 18—laser driving circuit board; 19—horizontal rotating bearing; 20—cleaning robot body.

### DETAILED DESCRIPTION OF THE EMBODIMENTS

### Description of the Embodiments

The present application will be further described below with reference to the embodiments and the drawings. It should be noted that the embodiments or technical features described below may be freely combined to form new embodiments on the premise of not causing any conflict.

It should be noted that when two elements are “fixedly connected” or “rotatably connected”, the two elements may be directly connected or be connected via an intermediate element. On the contrary, when an element is referred to as being “directly on” another element, there is no intermediate element. The terms “horizontal”, “vertical”, “transverse”, “upper”, “lower”, and similar expressions used herein are for descriptive purposes only. Unless otherwise defined, all technical and scientific terms used herein have the same meanings as those commonly understood by those skilled in the technical field of the present application. The terms used herein are only for the purpose of describing specific embodiments and are not intended to limit the present application.

Referring to FIG. 1, FIG. 2, FIG. 3, and FIG. 4, a first embodiment of a 3D laser radar according to the present application is as follows:

A 3D laser radar includes a vertical scanning unit, where the vertical scanning unit includes a mounting base 1 and a protective cover 16 directly fixed on the mounting base 1; a laser transmitting port 4, a convex lens 3, and a rotatable reflecting mirror 5 are horizontally provided between the mounting base 1 and the protective cover 16 in sequence, a rotation axis of the reflecting mirror 5 coincides with a main optical axis of the convex lens 3, and the laser transmitting port 4 is provided on the main optical axis of the convex lens 3; a laser signal horizontally transmitted from the laser transmitting port 4 achieves surrounding environment scanning in a vertical plane through reflection and rotation by the reflecting mirror 5; a light shielding chamber 51 is provided between a reflecting mirror 5 and a protective cover 16, the light shielding chamber 51 extends along a laser signal reflection direction and is provided on the rotation axis of the reflecting mirror 5, and an arc-shaped part 161 close to a rotation trajectory of an end portion of the light shielding chamber 51 is provided on the protective cover 16, such that a distance between the end portion and the arc-shaped part 161 remains unchanged during rotation of the light shielding chamber 51.

A second embodiment of a 3D laser radar according to the present application is as follows:

A 3D laser radar includes a vertical scanning unit, where the vertical scanning unit includes a mounting base 1 and a protective cover 16 fixed on the mounting base 1.

A laser transmitting port 4, a convex lens 3, and a rotatable reflecting mirror 5 are horizontally provided between the mounting base 1 and the protective cover 16 in sequence, a rotation axis of the reflecting mirror 5 coincides with a main optical axis of the convex lens 3, and the laser transmitting port 4 is provided on the main optical axis of the convex lens 3; a laser signal horizontally transmitted from the laser transmitting port 4 achieves surrounding environment scanning in a vertical plane through reflection and rotation by the reflecting mirror 5.

A light shielding chamber 51 is provided between a reflecting mirror 5 and a protective cover 16, the light shielding chamber 51 extends along a laser signal reflection direction and is provided on the rotation axis of the reflecting mirror 5, and an arc-shaped part 161 close to a rotation trajectory of an end portion of the light shielding chamber 51 is provided on the protective cover 16, such that a distance between the end portion and the arc-shaped part 161 remains unchanged during rotation of the light shielding chamber 51.

A third embodiment of a 3D laser radar according to the present application is as follows:

A 3D laser radar includes a rotatable reflecting mirror 5 used for reflecting a laser signal and a protective cover 16 of an arc-shaped structure.

A light shielding chamber 51 is provided between the protective cover 16 and the reflecting mirror 5; the light shielding chamber 51 is a cylindrical structure having an outer end portion with an arc rotation trajectory and being capable of rotating with the reflecting mirror 5.

An arc-shaped part 161 used for covering the light shielding chamber 51 is provided on the protective cover 16.

A portion or all of a sectional shape of the arc-shaped part 161 and the rotation trajectory of the outer end portion are concentric arcs to form a structure with an invariant gap, so that a distance between the end portion and the arc-shaped part 161 remains unchanged during rotation of the light shielding chamber 51.

A specific embodiment of additionally providing a transverse light shielding member according to the present application is as follows:

A transverse light shielding member is provided between the laser transmitting port 4 and the reflecting mirror 5, the transverse light shielding member includes a first light shielding member 52 fixed on the main optical axis of the convex lens 3 and a second light shielding member 53 directly fixed on and rotating with the reflecting mirror 5, and the second light shielding member 53 is sleeved with the first light shielding member 52; the transverse light shielding member is in communication with the light shielding chamber 51, and a light shielding pad 54 is provided at a portion of the second light shielding member 53 and the light shielding chamber 51 that is in contact with the reflecting mirror 5. By providing the transverse light shielding member in the horizontal direction, a transmitted laser signal is prevented from interfering with a laser signal on a return path, and refrains from leaking into an internal space of the protective cover 16 to interfere with the laser signal on the return path. The transverse light shielding member is set to be a structure consisting of the first light shielding member 52 and the second light shielding member 53 separated from each other, and the second light shielding member 53 is sleeved with the first light shielding member 52 on the outer side thereof, so as to avoid reflection of the transmitted laser signal by the second light shielding member 53 which may affect the scanning performance of the laser radar.

A specific embodiment of the vertical scanning unit according to the present application is as follows:

The vertical scanning unit includes a laser receiver 2 provided at a focus position of the convex lens 3, a first motor 6 driving the reflecting mirror 5 to rotate, a first encoder 7, and a laser driving circuit board 18.

The first encoder 7 is concentrically fixed and connected to the reflecting mirror 5, to acquire rotation information of the reflecting mirror 5 through the first encoder 7; the laser transmitting port 4 transmits a laser signal, and the reflecting mirror 5 is driven to rotate through the first motor 6, to achieve the surrounding environment scanning in the vertical plane.

A specific embodiment of additionally providing a horizontal rotating device according to the present application is as follows:

The 3D laser radar includes a horizontal rotating device driving the vertical scanning unit to rotate horizontally, where the horizontal rotating device includes an upper casing rotor 8, a lower casing 9, a horizontal rotating bearing 19, and a motor stator 10 fixed in the lower casing 9, the mounting base 1 and the protective cover 16 are fixed on and rotate with the upper casing rotor 8, and a mobile sealing structure 14 is provided between the upper casing rotor 8 and the lower casing 9. The horizontal rotating device drives the vertical scanning unit to rotate in the horizontal direction, enabling the single-threaded laser radar to achieve three-dimensional scanning. The mobile sealing structure 14 is provided to enhance overall waterproofness of the laser radar, enriching application scenarios thereof.

A specific embodiment of additionally providing a wireless power transmission module 12 according to the present application is as follows:

A hollow wireless power transmission module 12 is concentrically provided between the upper casing rotor 8 and the lower casing 9, and the wireless power transmission module 12 supplies power to the vertical scanning unit. Due to the relative rotation between the upper casing rotor 8 and the lower casing 9, when power supply and signal transmission are required, the wireless power transmission module 12 is used for replacing a conventional cable, thus avoiding fatigue damage of the cable during reciprocating rotation.

A specific embodiment of achieving wireless communication according to the present application is as follows:

A base circuit board 13 is fixedly provided on the lower casing 9, a wireless signal transmission component 17 is concentrically provided between the upper casing rotor 8 and the lower casing 9, and achieves wireless communication through optical communication; the vertical scanning unit achieves wireless communication with the base circuit board 13 through the wireless signal transmission component 17.

A specific embodiment of acquiring rotation information according to the present application is as follows:

Through holes 11 are uniformly provided along the same circle on a circumference of the upper casing rotor 8, and the through holes 11 form a photoelectric code disk to acquire rotation information of the upper casing rotor 8, thereby acquiring horizontal rotation information of the vertical scanning unit

A specific embodiment of additionally providing a magnetic steel sheet 15 according to the present application is as follows:

A magnetic steel sheet 15 is fixedly provided in the upper casing rotor 8, an axial width of the magnetic steel sheet 15 is greater than an axial width of the motor stator 10, and an upper edge of the magnetic steel sheet 15 is higher than an upper edge of the motor stator 10. The design of this structure enables the magnetic steel sheet 15 to be higher than the motor stator 10 by an amount in the vertical direction, making it possible to generate a large axial magnetic tension between the upper casing rotor 8 and the motor stator 10, thus making rotation of the horizontal rotating device more stable and reliable, and ensuring that the upper casing rotor 8 is not separated from the lower casing 9 during the rotation.

Referring to FIG. 5, a first specific embodiment of application of the 3D laser radar according to the present application is as follows:

A cleaning robot includes the 3D laser radar as described above and a cleaning robot body 20.

A second specific embodiment of application of the 3D laser radar according to the present application is as follows:

A legged robot includes the 3D laser radar as described above.

In the present application, the fixed connection may be screw connection, welding, riveting, inserting, or connection achieved via a third component, which can be selected by those skilled in the art according to an actual situation.

Finally, it should be noted that the above embodiments are only used to illustrate the technical solutions of the present application, rather than to limit them. Although the present application has been described in detail with reference to the above embodiments, those skilled in the art should understand that the specific embodiments of the present application may still be modified or replaced by equivalents, and any modifications or equivalent replacements that do not deviate from the spirit and scope of the present application shall be covered by the scope of protection of the claims of the present application.

1. A 3D laser radar, comprising a vertical scanning unit, wherein the vertical scanning unit comprises a mounting base and a protective cover fixed on the mounting base;
a laser transmitting port, a convex lens, and a rotatable reflecting mirror are horizontally provided between the mounting base and the protective cover in sequence, a rotation axis of the reflecting mirror coincides with a main optical axis of the convex lens, and the laser transmitting port is provided on the main optical axis of the convex lens; a laser signal horizontally transmitted from the laser transmitting port achieves surrounding environment scanning in a vertical plane through reflection and rotation by the reflecting mirror;
a light shielding chamber is provided between a reflecting mirror and a protective cover, the light shielding chamber extends along a laser signal reflection direction and is provided on the rotation axis of the reflecting mirror, and an arc-shaped part close to a rotation trajectory of an end portion of the light shielding chamber is provided on the protective cover, such that a distance between the end portion and the arc-shaped part remains unchanged during rotation of the light shielding chamber.

2. The 3D laser radar according to claim 1, wherein a transverse light shielding member is provided between the laser transmitting port and the reflecting mirror, the transverse light shielding member comprises a first light shielding member fixed on the main optical axis of the convex lens and a second light shielding member directly fixed on and rotating with the reflecting mirror, and the second light shielding member is sleeved with the first light shielding member;
the transverse light shielding member is in communication with the light shielding chamber, and a light shielding pad is provided at a portion of the second light shielding member and the light shielding chamber that is in contact with the reflecting mirror.

3. The 3D laser radar according to claim 2, wherein the vertical scanning unit comprises a laser receiver provided at a focus position of the convex lens, a first motor driving the reflecting mirror to rotate, and a first encoder;
the first encoder is concentrically fixed and connected to the reflecting mirror, to acquire rotation information of the reflecting mirror through the first encoder;
the laser transmitting port transmits a laser signal, and the reflecting mirror is driven to rotate through the first motor, to achieve the surrounding environment scanning in the vertical plane.

4. The 3D laser radar according to claim 1, comprising a horizontal rotating device driving the vertical scanning unit to rotate horizontally, wherein the horizontal rotating device comprises an upper casing rotor, a lower casing and a motor stator fixed in the lower casing, the mounting base and the protective cover are fixed on and rotate with the upper casing rotor, and a mobile sealing structure is provided between the upper casing rotor and the lower casing.

5. The 3D laser radar according to claim 4, wherein a hollow wireless power transmission module is concentrically provided between the upper casing rotor and the lower casing, and the wireless power transmission module supplies power to the vertical scanning unit;
or/and through holes are uniformly provided along the same circle on a circumference of the upper casing rotor, and the through holes form a photoelectric code disk to acquire rotation information of the upper casing rotor, thereby acquiring horizontal rotation information of the vertical scanning unit;
or/and a magnetic steel sheet is fixedly provided in the upper casing rotor, an axial width of the magnetic steel sheet is greater than an axial width of the motor stator, and an upper edge of the magnetic steel sheet is higher than an upper edge of the motor stator.

6. The 3D laser radar according to claim 5, wherein a base circuit board is fixedly provided on the lower casing, a wireless signal transmission component is concentrically provided between the upper casing rotor and the lower casing, and achieves wireless communication through optical communication; the vertical scanning unit achieves wireless communication with the base circuit board through the wireless signal transmission component.

7. A 3D laser radar, comprising a rotatable reflecting mirror used for reflecting a laser signal and a protective cover of an arc-shaped structure, wherein
a light shielding chamber is provided between the protective cover and the reflecting mirror; the light shielding chamber is a cylindrical structure having an outer end portion with an arc rotation trajectory and being capable of rotating with the reflecting mirror;
an arc-shaped part used for covering the light shielding chamber is provided on the protective cover; a portion or all of a sectional shape of the arc-shaped part and the rotation trajectory of the outer end portion are concentric arcs to form a structure with an invariant gap, so that a distance between the end portion and the arc-shaped part remains unchanged during rotation of the light shielding chamber.

8. The 3D laser radar according to claim 7, wherein
the cylindrical structure is an L-shaped structure with a vertical segment used for receiving a laser signal reflected from the reflecting mirror and a transverse segment used for receiving a laser signal transmitted from a convex lens;
the vertical segment extends towards a wall of the protective cover and is adjacent to the wall of the protective cover;
a first light shielding member is provided on the convex lens;
the transverse segment of the L-shaped structure is sleeved with the first light shielding member on the outer side thereof.

9. A laser radar with high scanning performance, comprising a laser transmitter used for transmitting a laser signal, a rotatable reflector used for reflecting a laser signal, and a protective housing of an arc-shaped structure, wherein
the protective housing covers the reflector;
a light shielding chamber is provided between the reflector and the protective housing;
the light shielding chamber is a cylindrical member which extends in a direction from an end face of the reflector to a wall of the protective housing.

10. The laser radar with high scanning performance according to claim 9, wherein
the laser transmitter is arranged transversely and is provided with a laser transmitting port;
the reflector is provided with a reflecting face arranged obliquely;
an extension line where the laser transmitting port is located intersects the reflecting face;
the cylindrical member is an L-shaped structure with a vertical segment used for receiving a laser signal reflected from the reflector and a transverse segment used for receiving a laser signal transmitted from a convex lens;
the vertical segment extends towards a wall of the protective housing and is adjacent to the wall of the protective housing;
a first light shielding member is provided on the convex lens, and a laser receiver is provided at a focus position of the convex lens;
the transverse segment of the L-shaped structure is sleeved with the first light shielding member on the outer side thereof;
the cylindrical member is provided on a rotation axis of the reflector, and an outer end thereof has an arc rotation trajectory and is capable of rotating with the reflector;
an arc-shaped part used for covering the light shielding chamber is provided on the protective housing; a portion or all of a sectional shape of the arc-shaped part and the rotation trajectory of the outer end portion are concentric arcs to form a structure with an invariant gap, so that a distance between the end portion and the arc-shaped part remains unchanged during rotation of the light shielding chamber;
the rotation axis of the reflector coincides with a main optical axis of the convex lens, and the laser transmitting port is provided on the main optical axis of the convex lens; a laser signal horizontally transmitted from the laser transmitting port achieves surrounding environment scanning in a vertical plane through reflection and rotation by the reflector;
a transverse light shielding member is provided between the laser transmitter and the reflector, the transverse light shielding member comprises the first light shielding member fixed on the main optical axis of the convex lens and a second light shielding member directly fixed on and rotating with the reflector, and the second light shielding member is sleeved with the first light shielding member;
the transverse light shielding member is in communication with the light shielding chamber, and a light shielding pad is provided at a portion of the second light shielding member and the light shielding chamber that is in contact with the reflector.

11. A robot using the 3D laser radar according to claim 1 to achieve real-time scanning of surrounding environment information, wherein
the robot is a legged robot or a cleaning robot.

12. A robot comprising the laser radar with high scanning performance according to claim 9, wherein the robot is a legged robot or a cleaning robot.
